(19) United States
(12) Patent Application Publication
(10) Pub. No.: US 2025/0054017 A1
(43) Pub. Date: Feb. 13, 2025

(54) INFORMATION PROCESSING DEVICE

(71) Applicant: TOYOTA JIDOSHA KABUSHIKI KAISHA, Toyota-shi (JP)

(72) Inventors: Yohei NAKANISHI, Nagoya-shi (JP); Yu Hamada, Nagoya-shi (JP); Kenta Kawashima, Nagoya-shi (JP); Yuichi Mukasa, Kawaguchi-shi (JP); Keisuke kondo, Nagoya-shi (JP)

(73) Assignee: TOYOTA JIDOSHA KABUSHIKI KAISHA, Toyota-shi (JP)

(21) Appl. No.: 18/772,495

(22) Filed: Jul. 15, 2024

(30) Foreign Application Priority Data
Aug. 10, 2023 (JP) 2023-130964

(51) Int. Cl. G06Q 30/0226; G06Q 10/20

(52) U.S. Cl. CPC G06Q 30/0226; G06Q 10/20

(57) ABSTRACT

An information processing device includes a control unit. The control unit of the information processing device acquires the number of times of maintenance performed at a predetermined station during a predetermined period of time for the leased vehicle including the maintenance. The control unit of the information processing device determines a larger amount of reward to be provided to the user of the leased vehicle as the number of times of maintenance performed at a predetermined station during a predetermined period of time is smaller. The control unit of the information processing device outputs information of the determined reward.

### CROSS-REFERENCE TO RELATED APPLICATION

This application claims priority to Japanese Patent Application No. 2023-130964 filed on Aug. 10, 2023 incorporated herein by reference in its entirety.

### BACKGROUND

### 1. Technical Field

The present disclosure relates to an information processing device.

### 2. Description of Related Art

There is known a method of selling fuel to leased vehicles, in which a discount rate of fuel charges is greater for a leased vehicle regarding which oil changing is included as a maintenance item of a lease contract, as compared to that of a leased vehicle regarding which oil changing is not included as a maintenance item of the lease contract (e.g., see Japanese Unexamined Patent Application Publication No. 2020-38708 (JP 2020-38708 A)).

### SUMMARY

It is an object of the present disclosure to provide technology that is effective in correcting unfairness among a plurality of users using a lease service with maintenance provided.

One aspect of the present disclosure is an information processing device. The information processing device in such a case, for example, includes a control unit that is configured to execute acquiring a count of times of maintenance carried out at a predetermined station during a predetermined period of time for a leased vehicle with maintenance provided, and outputting information of regarding a reward, in which an amount provided to a user of the leased vehicle increases the lower the count of times of maintenance is.

Another aspect of the present disclosure may be an information processing method in which a computer executes the above-described processing, a program for causing the computer to execute the information processing method, or a non-transitory storage medium storing the program.

According to the present disclosure, technology that is effective in correcting unfairness among a plurality of users using a lease service with maintenance provided can be provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of a vehicle management system;

FIG. 2 is a diagram illustrating an example of maintenance information;

FIG. 3 is a diagram illustrating an example of information stored in a maintenance DB;

FIG. 4 is a diagram illustrating an example of the incentive information; and

FIG. 5 is a flowchart illustrating a process flow that is periodically executed by the server.

### DETAILED DESCRIPTION OF EMBODIMENTS

A lease service is known in which a user who pays a fixed usage fee (monthly usage fee) on a regular basis (for example, every month) is granted a right to use a vehicle. As one aspect of the lease service, a lease service including maintenance is also known. A lease service including maintenance is a service that allows maintenance of vehicles (such as vehicle inspection, inspection, and maintenance) during a lease period without an additional fee, and the maintenance fee is preliminarily included in a lease fee (such as an application fee and/or a monthly usage fee).

Here, in the lease service including maintenance, the maintenance time is determined in advance for each item. For example, for the engine oil, the maintenance time is determined so as to be replaced at a constant traveling distance or at a constant period of time. However, depending on how the vehicle is driven by the user, a predetermined maintenance time may not be appropriate. For example, in a vehicle of a user that performs an operation in which engine oil is hardly deteriorated, there is a possibility that the engine oil does not deteriorate to an extent that the engine oil needs to be replaced within a predetermined constant traveling distance or a predetermined period of time. In such a case, if the oil change is performed according to a predetermined constant travel distance or a predetermined period of time, excessive consumption of the engine oil resource may be caused.

Therefore, in a lease service including maintenance, a method of flexibly determining a maintenance time according to a vehicle state is conceivable. However, when such a method is adopted, a situation may occur in which the number of times of maintenance performed during the lease period is different for each user. That is, the number of maintenance times may be different among a plurality of users to which the same lease fee is charged. As a result, there is a possibility that a user having a relatively small number of maintenance times feels unfair.

On the other hand, in the information processing device according to the present disclosure, the control unit acquires the number of times of maintenance performed at a predetermined station for a leased vehicle including maintenance during a predetermined period of time. A leased vehicle including maintenance is a vehicle that is an object of the above-described leased service including maintenance. The predetermined station is a maintenance factory operated by a lease service provider or a maintenance factory operated by a contractor commissioned by a lease service provider. The predetermined period of time may be a lease period or some period of time (e.g., months to one year) during the lease period.

The control unit outputs information of a reward that increases the amount provided to the user of the leased vehicle as the number of times of maintenance acquired decreases. The reward may be any reward as long as it can suppress a user who has a relatively small number of maintenance times from feeling unfairness. In one example, the reward may be a discount on the lease fee. As another example, the reward may be a coupon, a point, a gift certificate, or the like. Note that the control unit may be configured to further execute determining the amount of the reward according to the number of times of maintenance for each item. As an example, the amount of rewards may be determined to be larger as the number of maintenance steps required for maintenance increases and/or the number of maintenance times of items having a high price of parts to be replaced in maintenance decreases.

The outputting of the information of the reward in the information processing device according to the present disclosure may include presenting the information of the reward to the operator through a display included in the information processing device, and/or transmitting the information of the reward to the terminal of the user.

According to the present disclosure, it is possible to suppress a user having a relatively small number of maintenance times from feeling unfairness.

### Embodiment

Hereinafter, an embodiment of the present disclosure will be described with reference to the drawings. The configurations of the following embodiments are illustrative, and the present disclosure is not limited to the configurations of the embodiments.

### Overview of Vehicle Management System

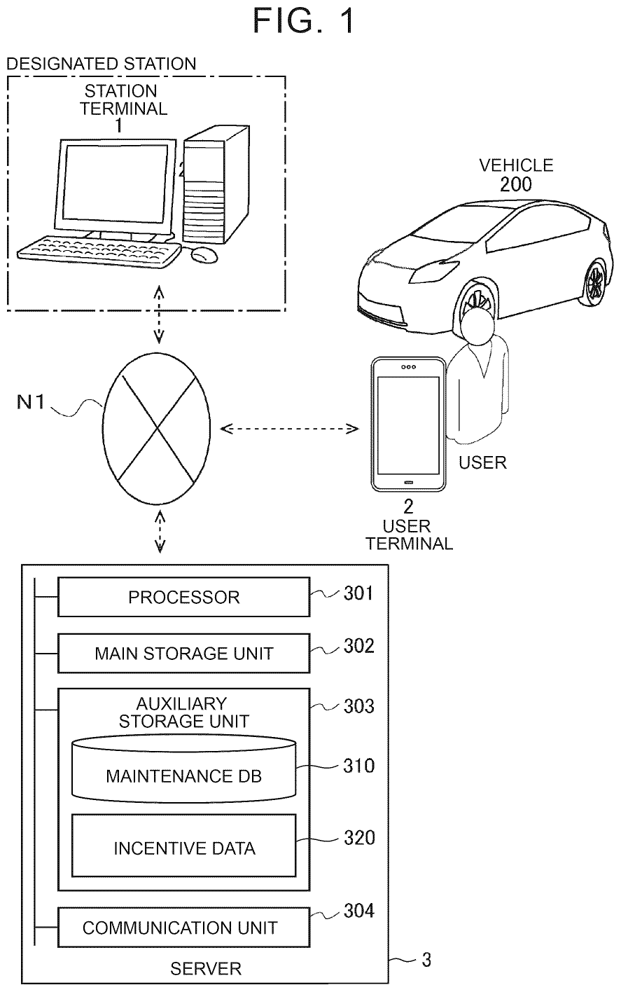

A system to which the information processing device according to the present disclosure is applied will be described with reference to FIG. 1. FIG. 1 is a diagram illustrating an outline of a system. The system according to the present embodiment includes a station terminal 1, a user terminal 2, and a server 3. The server 3 is connected to the station terminal 1 and the user terminal 2 through a network N1 described later. In the example illustrated in FIG. 1, only one station terminal 1 and one user terminal 2 are illustrated, but a plurality of station terminals 1 and user terminals 2 may be included in the system.

The station terminal 1 is a terminal arranged at a predetermined station. The predetermined station is a maintenance factory operated by the lease service provider or a maintenance factory commissioned by the lease service provider, and performs maintenance of the vehicle 200. The user terminal 2 is a terminal used by a user of the vehicle 200. The vehicle 200 is a leased vehicle in which a user is granted usage rights by paying a flat usage fee periodically (for example, every month). In the present embodiment, the lease contract for the vehicle 200 includes a contract in which maintenance (vehicle inspection, inspection, maintenance, and the like) during the lease period is received without an additional fee. The server 3 is an example of an information processing device according to the present disclosure, and is operated by a lease service provider. The server 3 has a function of periodically collecting the driving history of the vehicle 200, the diagnosis information, and the like from the vehicle 200, and determining the maintenance time of the vehicle 200 based on the collected information. Further, the server 3 has a function of notifying the user of the determined maintenance time through the user terminal 2. Thus, the number of times of maintenance can be reduced for the vehicle 200 of the user who performs driving in which the vehicle components are less likely to deteriorate. Further, the server 3 of the present embodiment has a function of determining an incentive (reward) to be provided to the user in accordance with the number of times of maintenance (the number of times of maintenance) received by the vehicle 200 at a predetermined station during a predetermined period of time. As a result, it is possible to suppress a user who has a small number of times of maintenance of the vehicle 200 (a user who performs driving in which vehicle components are difficult to deteriorate) from feeling unfair.

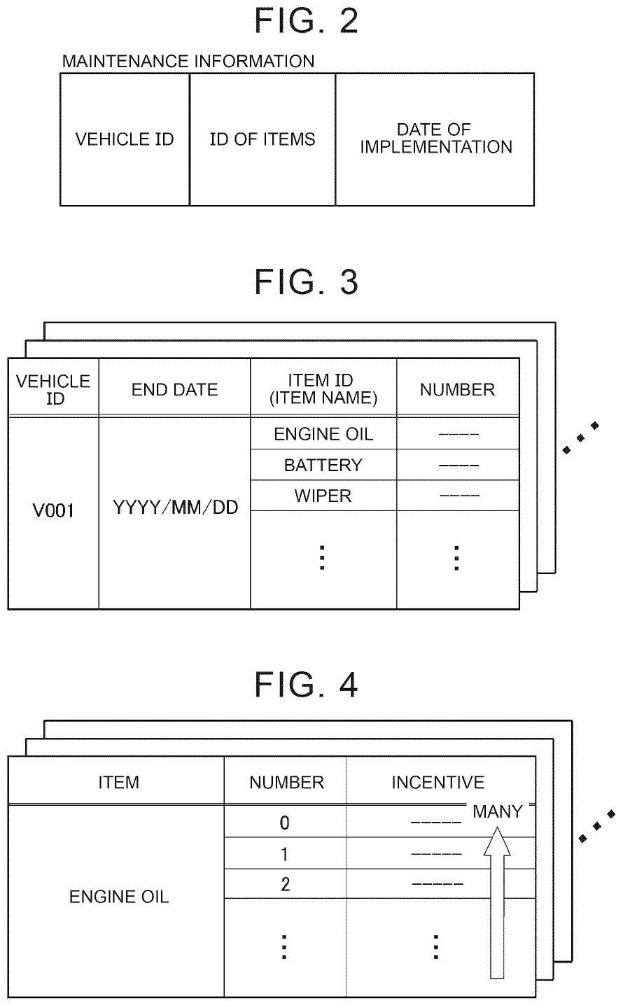

In the system of the present embodiment, each time the maintenance of the vehicle 200 is performed at a predetermined station, an employee or the like at the predetermined station transmits the maintenance information to the server 3 through the station terminal 1. In one embodiment, as illustrated in FIG. 2, the maintenance information includes an identifier of the vehicle 200 (vehicle ID), an identifier of a maintenance item (item ID) performed at a predetermined station, and a date (execution date) on which the maintenance of the vehicle 200 is performed at the predetermined station. The item ID included in the maintenance information may be an item name of the maintenance.

Based on such maintenance information, the server 3 obtains the number of times of maintenance for each item received by the vehicle 200 during a predetermined period of time, and determines an incentive in accordance with the number of times of maintenance for each item. The incentive may be any incentive as long as it can suppress a user who has a relatively small number of maintenance times from feeling unfairness. As an example, the incentive may be a discount on the lease fee. As another example, the incentive may be a coupon, a point, a gift certificate, or the like. The server 3 outputs the information of the incentive determined as described above.

### Configuration of Server

Here, the configuration of the server 3 according to the present embodiment will be described. As illustrated in FIG. 1, the server 3 of the present embodiment includes a processor 301, a main storage unit 302, an auxiliary storage unit 303, and a communication unit 304. Note that the configuration of the server 3 is not limited to the example illustrated in FIG. 1, and may include an input/output device in addition to the processor 301, the main storage unit 302, the auxiliary storage unit 303, and the communication unit 304.

The processor 301 is, for example, Central Processing Unit (CPU) or Digital Signal Processor (DSP). The processor 301 loads a program stored in the auxiliary storage unit 303 into a work area of the main storage unit 302 and executes the program, thereby realizing a function that matches a predetermined purpose. In the present embodiment, the processor 301 that executes a program stored in the auxiliary storage unit 303 corresponds to a control unit according to the present disclosure.

The main storage unit 302 is a computer-readable recording medium. In the present embodiment, the main storage unit 302 is used as a work area for loading a program stored in the auxiliary storage unit 303, and is used as a buffer for temporarily storing calculation results and the like of the processor 301. The main storage unit 302 includes, for example, Random Access Memory (RAM) and Read Only Memory (ROM).

The auxiliary storage unit 303 is a computer-readable recording medium. In the present embodiment, the auxiliary storage unit 303 stores various programs to be executed by the processor 301, various data used when the processor 301 executes the various programs, and the like. The auxiliary storage unit 303 includes, for example, Erasable Programmable ROM (EPROM) or Hard Disk Drive (HDD). The auxiliary storage unit 303 may include a removable medium, that is, a portable recording medium. In addition to Operating System (OS), the program stored in the auxiliary storage unit 303 includes a program for determining an incentive provided to the user of the vehicle 200. Note that some or all of the information stored in the auxiliary storage unit 303 may be stored in the main storage unit 302.

Maintenance DB 310 and incentive data 320 are stored in the auxiliary storage unit 303 in the present embodiment. The maintenance DB 310 is constructed by the processor 301 executing a program of Database Management System (DBMS).

The maintenance DB 310 is a data base that stores information on the number of times of maintenance performed on the vehicle 200 at a predetermined station during a predetermined time. The predetermined period of time may be, for example, a lease period of the vehicle 200 or a partial period of the lease period (e.g., several months to one year).

FIG. 3 is a diagram illustrating exemplary data stored in a maintenance DB 310. As illustrated in FIG. 3, the maintenance DB 310 includes a plurality of tables (hereinafter, also referred to as “maintenance information tables”) corresponding to each of the plurality of vehicles 200 managed by the server 3. In addition to the field in which the vehicle ID of the corresponding vehicle 200 is registered and the field in which the end date of the predetermined period is registered, the respective maintenance information tables include a plurality of records for each maintenance item that matches the corresponding vehicle 200. In the example illustrated in FIG. 3, each record includes an item ID field in which an identifier (item ID) of an item to be maintained is registered, and a number-of-times field in which a cumulative number of times the maintenance of each item is performed at a predetermined station during a predetermined time period (the number of times of maintenance) is registered. In the example illustrated in FIG. 3, the item names such as “engine oil”, “battery”, and “wiper” are used as the information registered in the item ID field, but the identifier may be an identifier other than the item name.

The information registered in the number-of-times field in each maintenance information table of the maintenance DB 310 is updated every time the maintenance of each item for the corresponding vehicle 200 is performed at a predetermined station. For example, when the engine oil of the vehicle 200 is replaced at a predetermined station, the maintenance information including the vehicle ID of the vehicle 200, the item ID corresponding to the engine oil, and the execution date of the engine oil change is transmitted from the station terminal 1 to the server 3. In the server 3 that has received such maintenance information, the maintenance information table of the vehicle 200 is specified based on the vehicle ID. Subsequently, in the server 3, among the records of the identified maintenance information table, the record registered as “engine oil” in the item ID field is identified, and the number of times of maintenance registered in the number field of the identified record is incremented by one.

When the predetermined period is a part of the period during the lease period, the information registered in the number-of-times field in the maintenance information tables of the maintenance DB 310 is reset to “0 times” each time the end date of the predetermined period arrives.

The incentive data 320 is data in which the amount of the incentive for each item of maintenance is determined. FIG. 4 is a diagram illustrating an example of the incentive data 320. As illustrated in FIG. 4, the incentive data 320 includes a plurality of tables (hereinafter, sometimes referred to as “incentive data tables”) for each item of maintenance. In each incentive data table, the amount of incentives is set for each item in the number of maintenance times. In the present embodiment, the amount of the incentive is set to be larger as the number of times of maintenance of each item is smaller. With respect to the “engine oil” illustrated in FIG. 4, the smaller the number of times of maintenance (the number of times of changing the engine oil), the larger the amount of incentive. In the present embodiment, the amount of the incentive is set to be different for each item. As an example, the amount of incentive when the number of maintenance times is small may be set to be larger than the amount of items in which the number of man-hours required for maintenance is large. As another example, an item having a high price (component cost) of a component to be replaced in maintenance may be set so that the amount of incentive when the number of times of maintenance is small is further increased as compared with an item having a low price.

Next, the communication unit 304 of the server 3 is an interface for connecting the server 3 to the network N1. In one embodiment, the communication unit 304 is configured to include a Local Area Network (LAN) interface board, wireless communication circuitry for wireless communication, and the like. In the present embodiment, the communication unit 304 communicates with the station terminal 1 and the user terminal 2 through the network N1.

In the server 3 configured as described above, when the communication unit 304 receives the maintenance information transmitted from the station terminal 1, the processor 301 executes the following processing through execution of the program stored in the auxiliary storage unit 303. First, the processor 301 identifies the maintenance information table corresponding to the vehicle 200 by accessing the maintenance DB 310 using the vehicle ID included in the maintenance information as an argument. The processor 301 accesses the specified maintenance information table using the item ID included in the maintenance information as an argument, thereby specifying a record in which information matching the item ID is registered in the item ID field. As an example, if the item ID included in the maintenance information is “engine oil”, the processor 301 identifies a record registered as “engine oil” in the item ID field. The processor 301 increments the number of maintenance times registered in the number-of-times field of the identified record by one.

In the server 3 configured as described above, the processor 301 periodically (for example, every day) executes the following processing through execution of the program stored in the auxiliary storage unit 303. First, the processor 301 accesses the maintenance DB 310 to determine whether there is any vehicle 200 whose predetermined duration has expired. For example, if the maintenance information table registered in the maintenance DB 310 includes the maintenance information table in which the date one day before is registered in the end date field, the processor 301 may determine that the predetermined period of the vehicle 200 corresponding to the maintenance information table has ended.

When it is determined that there is a vehicle 200 in which the predetermined period has ended, the processor 301 obtains an incentive amount for each item of maintenance based on the information registered in the maintenance information table of the vehicle 200 and the incentive data 320. Here, taking the item “engine oil” as an example, the processor 301 identifies a record registered as “engine oil” in the item ID field of the maintenance information table, and reads the number of maintenance times registered in the number-of-times field of the identified record. Subsequently, the processor 301 accesses the incentive data 320 to identify an incentive data table corresponding to the engine oil. The processor 301 reads an incentive amount corresponding to the number of times of maintenance read from the maintenance information table, out of the incentive amounts registered in the identified incentive data table. The processor 301 sets the incentive amount read from the incentive data table to an incentive amount corresponding to the item “engine oil”. The same process is executed for other items registered in the item ID field of the maintenance-information table.

When the incentive amount is determined for all items registered in the item ID field of the maintenance-information table, the processor 301 calculates the sum of the incentive amounts. The processor 301 determines the computed summation as the amount of incentive provided to the user of the vehicle 200. The processor 301 outputs information on the determined amount of incentive (hereinafter, may be referred to as “incentive information”). Outputting the incentive information may include presenting the incentive information to the operator through the input/output device of the server 3, presenting the incentive information to the user through the user terminal 2, presenting the incentive information to the lease service provider through the terminal of the lease service provider, and the like.

The method of determining the amount of incentive provided to the user of the vehicle 200 is not limited to the above-described example, and can be flexibly changed according to the embodiment. For example, the processor 301 may determine the amount of incentive provided to the user of the vehicle 200 in accordance with the sum of the number of maintenance times by item. In this case, the processor 301 may increase the amount of incentive provided to the user of the vehicle 200 as the total number of maintenance items is smaller.

### Processing Flow

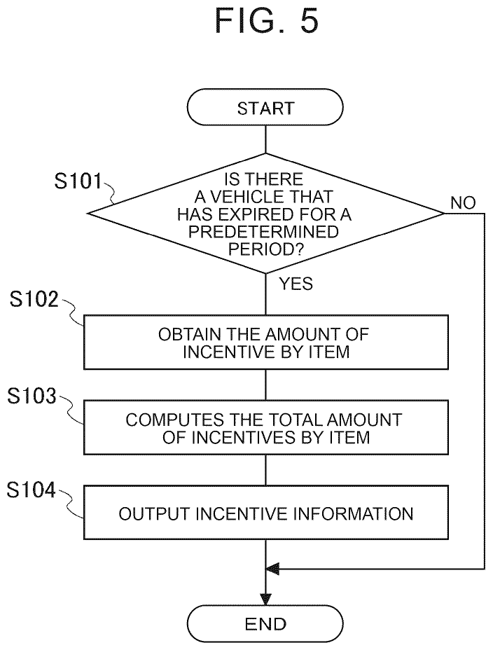

A flow of processing executed by the server 3 in the present embodiment will be described with reference to FIG. 5. FIG. 5 is a flowchart illustrating a process flow executed by the server 3 periodically (for example, every day).

In FIG. 5, the processor 301 determines whether or not there is a vehicle 200 whose predetermined duration has ended among the vehicles 200 managed by the server 3 (S101). Specifically, the processor 301 accesses the maintenance DB 310 to determine whether there is a maintenance info table in which a date one day ago is registered in the end date field. If there is no maintenance information table in which the date one day before is registered in the end date field, the processor 301 determines that there is no vehicle 200 for which the predetermined period has ended (negative determination in S101). In this case, the processor 301 ends the execution of this processing routine. If there is a maintenance information table in which the date one day before is registered in the end date field, the processor 301 determines that the predetermined period of the vehicle 200 corresponding to the maintenance information table has ended (affirmative determination in S101). Then, the processor 301 executes S102 process.

In S102, the processor 301 acquires an item-specific incentive quantity for the vehicle 200 determined to have expired in S101. Specifically, the processor 301 accesses the incentive data 320 using the number of maintenance times of each item registered in the maintenance information table of the vehicle 200 as an argument, thereby acquiring an incentive amount for each maintenance item. When the incentives are obtained for all the items registered in the item ID field of the maintenance information table of the vehicle 200, the processor 301 executes S103 process.

In S103, the processor 301 computes the sum of the items-specific incentives obtained in S102. When the processor 301 finishes executing S103 process, it executes S104 process.

In S104, the processor 301 outputs an incentive-information including the sum calculated by S103. In an example, the processor 301 may present the incentive information to the operator through the input/output device of the server 3. In another example, the processor 301 may transmit the incentive information to the user terminal 2 (present to the user) or may transmit the incentive information to the terminal of the lease service provider (present to the lease service provider) through the communication unit 304. When the processor 301 finishes executing S104 process, it finishes executing the process of FIG. 5.

According to the above-described embodiment, the more incentives are provided as the number of times of maintenance is relatively small among a plurality of users who use a lease service including maintenance (among a plurality of users who are charged the same lease fee). As a result, it is possible to suppress a user having a relatively small number of maintenance times from feeling unfair.

### Modified Examples

In the above-described embodiment, the server 3 is configured by one computer, but may be configured by a plurality of computers connected to each other via the network N1. That is, the processes of the server 3 described in the above-described embodiments may be shared and executed by a plurality of computers connected to each other via the network N1.

What is claimed is:

1. An information processing device comprising a control unit that is configured to execute
acquiring a count of times of maintenance carried out at a predetermined station during a predetermined period of time for a leased vehicle with maintenance provided, and
outputting information of regarding a reward, in which an amount provided to a user of the leased vehicle increases the lower the count of times of maintenance is.

2. The information processing device according to claim 1, wherein the predetermined period of time is a period of at least a part of a lease period.

3. The information processing device according to claim 1, wherein the control unit is configured to further execute deciding the amount of the reward provided to the user in accordance with an item-specific count of times of maintenance.
